(19) United States
(12) Patent Application Publication
(10) Pub. No.: US 2009/0164951 A1
(43) Pub. Date: Jun. 25, 2009

(54) Input architecture for devices with small input areas and executing multiple applications

(75) Inventor: Rakesh Kumar, Hyderabad (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 11/959,490

(22) Filed: Dec. 19, 2007

(51) Int. Cl. G06F 3/033

(52) U.S. Cl. 715/863

(57) ABSTRACT

A run time environment (e.g., operating system, device drivers, etc.) which translates a touch gesture representing one or more directions on a touch screen to a corresponding choice and indicates the same to a user application. As the choice depends merely on the direction(s) of movement of the touch, choices can be easily indicated for all applications executing in a device with small input areas.

### BACKGROUND

1. Field of Disclosure

The present disclosure relates generally to devices with small input areas, and more specifically to an input architecture for such devices which execute multiple applications.

2. Related Art

There are several devices which are provided with small input areas. For example, cell phones, personal digital assistants (PDAs), etc., are often provided with small key-boards, primarily to reduce the overall size of the device.

Applications executing on such devices often require user inputs. For example, an application often requires a user to input Yes/No, Next Step/Back/Cancel, OK/Cancel, up/down/left/right, etc.

Providing such inputs using small input areas is often problematic. For example, in case of a small keyboard, the finger tip is often large compared to the area occupied by individual keys (of a keyboard), and accordingly the user may unintentionally press the wrong key or multiple keys. Neither scenario is often desirable.

Accordingly what is needed is an approach which simplifies providing user inputs based on small input areas.

### BRIEF DESCRIPTION OF THE DRAWINGS

Example embodiments will be described with reference to the following accompanying drawings, which are described briefly below.

FIG. 1 is a diagram illustrating an example device in which several aspects of the present invention may be implemented.

FIG. 2 is a block diagram illustrating an architecture for devices with small input areas and executing multiple applications in an embodiment of the present invention.

FIG. 3 is a flowchart illustrating the manner in which touch data may be processed to determine a user choice, in an embodiment of the present invention.

FIGS. 4A-4C depicts logically the configuration tables stored in a memory of a handheld device for respective applications, in an embodiment of the present invention.

FIG. 5 is a block diagram illustrating the details of a device with small input area in an embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

A device provided according to an aspect of the present invention executes multiple user applications and translates a touch gesture on a touch screen to a corresponding user choice. The user choice is then provided to a user application. The touch gesture can be in the form of simple directions (e.g., up, down, left, right, etc.), and as a result, the task of providing user choices may be simplified even on small input areas.

In an embodiment, the translations are performed by a runtime environment (e.g., operating system, device drivers, etc.) which are shared by the user applications. As a result, the translations can potentially be performed for all applications executing in a device.

According to another aspect of the present invention, a mapping data is maintained indicating the specific user choice corresponding to a set of directions forming a touch gesture. Depending on the directions detected in the touch gesture, the corresponding user choice (according to the mapping) is presented to the user application.

According to another aspect of the present invention, the mapping data is configurable by a user for each application such that a user can obtain a desired customization.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

2. Example Environment

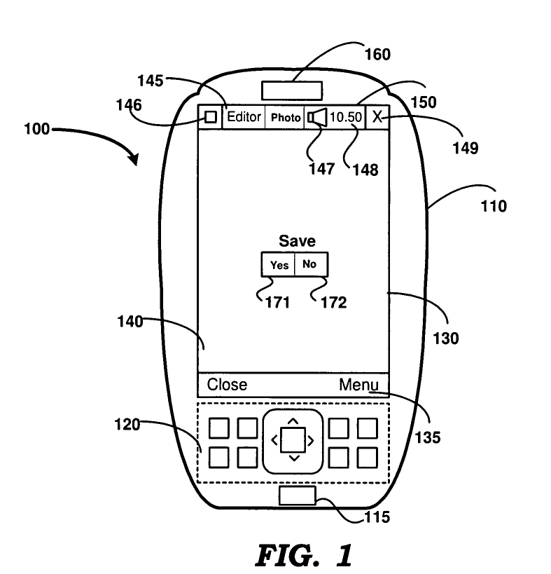

FIG. 1 is a diagram of a handheld device representing a device with small input area in which several aspects of the present invention may be implemented. The device can correspond to mobile phones, personal organizers, personal digital assistants (PDA), etc. Handheld 100 is shown containing case enclosure 110, keys 120, mic (microphone) 115, speaker 160 and touch screen 130. Touch screen 130 is shown with a display having three portions 135, 140 and 145. Each block is described in further detail below

The block diagram is shown containing only representative blocks for illustration. However, real-world handhelds may contain more/fewer/different components/blocks, both in number and type, depending on the purpose for which the handheld is designed, as will be apparent to one skilled in the relevant arts. For example, though keys 120 is shown containing a small number of keys, handhelds may have no keys at all, have alpha numeric keyboards, or have hidden keys, which for example may slide out of the enclosure. Similarly, handhelds may not have mic 115 or speaker 120 (especially if the handheld does not integrate functions such as mobile telephony or playing music, thus not having a requirement of audio interfaces). Handhelds may also have additional components such as cameras, provision such as USB ports for communication with other devices, etc.

Case enclosure 110 represents a part enclosing all the components of handheld 100 merely to shield any unneeded exposure of the internal components (not shown/described), in addition to holding components such as keys 120, touch screen 130, speaker 160 and mic 115 in place. It should be appreciated that the design of enclosure 110 and various other details provided herein, are merely exemplary. Various other alternative embodiments can be implemented without departing from the scope and spirit of several aspects of the present invention, as will be apparent to one skilled in the relevant arts by reading the disclosure provided herein.

Microphone 115 represents a component which converts voice (sound) of a user into electrical signals representing the voice. The converted electrical signals may be further processed and transmitted over a mobile/wireless network (if handheld 100 incorporates mobile telephony functionality) or stored in a memory etc. Speaker 160 represents a component which converts electrical signals representing sound into sound. The electrical signal representing sound may be received over a mobile/wireless network (if handheld 100 incorporates mobile telephony functionality) or generated by an internal audio player such as a music player (not shown) if provided, etc.

Keys 120 represents a component for providing user input to the handheld. Keys 120 may be used to provide user selections (such as up, down, select, cancel etc) from icons or menus displayed on touch screen 130. The keys may also be used to provide alphanumeric inputs (for example, to compose a message, store contact details, etc.) or make voice calls (if handheld 100 incorporates mobile telephony functionality), etc.

Touch screen 130 represents a display screen designed to facilitate detection of touch actions. In an embodiment, touch screen 130 is implemented to provide the coordinates of touch and the corresponding (relative or absolute) time points of the touch action. This information together represents the movement (in terms of direction, speed, etc.) of an object on the touch screen.

The display on touch screen 130 is shown having three portions 135, 140 and 145. Portion 145 is shown displaying icons corresponding to the applications (“Editor” , “Photo”, speaker volume 147 and time 148). The user is assumed to have selected Editor application and the remaining two portions correspond to the editor application.

Portion 135 is shown displaying a Menu icon representing various action choices the user can select for the present application of Editor. Portion 135 also contains a Close icon, which can be selected by the user to close the present application Editor. Also displayed are icon 146 representing “start” (which can be selected to view all available applications) and another icon 149 to terminate the present window being displayed on the display screen.

Display portion 140 represents the area where the display corresponding to the active application (a particular application out of many applications that are executing at a time, that a user is interacting with at a given time) is presented to a user. Portion 140 also displays prompts (warnings, error messages, presenting a set of user choices such as Yes 171 and No 172 and requesting a user for appropriate inputs, etc.) generated by applications.

In general, portion 140 displays the output of the applications and prompts where as portions 135 and 145 displays status messages and icons related to executing applications.

Merely for illustration, the display area is also implemented to be a touch area. However, in alternative embodiments, the display area (which displays the save prompt) can be physically separated (non-overlapping) from the touch area (the touch movements on which are communicated to the processors within the handheld). Such alternative embodiments are also contemplated to be within the scope and spirit of various aspects of the present invention.

A user may provide inputs to applications by touching appropriate selection boxes on the touch screen. For example, for the Save prompt shown there, a user may touch Yes 171 to save or touch No 172 to not save. However, as touch screen 130 in general and display portion 140 in particular, is of small size, a user may find it tedious to make the user choice in this manner, by touching the correct selection box (without, for example, touching adjacent selection boxes).

Similarly, the key board 120 may either be small or non-existent to be able to provide the Yes or no inputs. Further, in alternative embodiments, a small key-board may be the only input device to provide such inputs. In general, when the input area is small, challenges may be presented in providing precise user inputs irrespective of the nature of the input component.

According to an aspect of the present invention, a user may make one or more movements (movement refers to the actions performed by a user on touch screen 130, between touching the touch screen 130 and removing the touch from touch screen 130) on touch screen 130 to provide the user choice, without being restricted to the selection boxes (such as those shown for Yes 171 and No 172), to provide the appropriate user choice to applications, as described below with examples.

3. Device Architecture

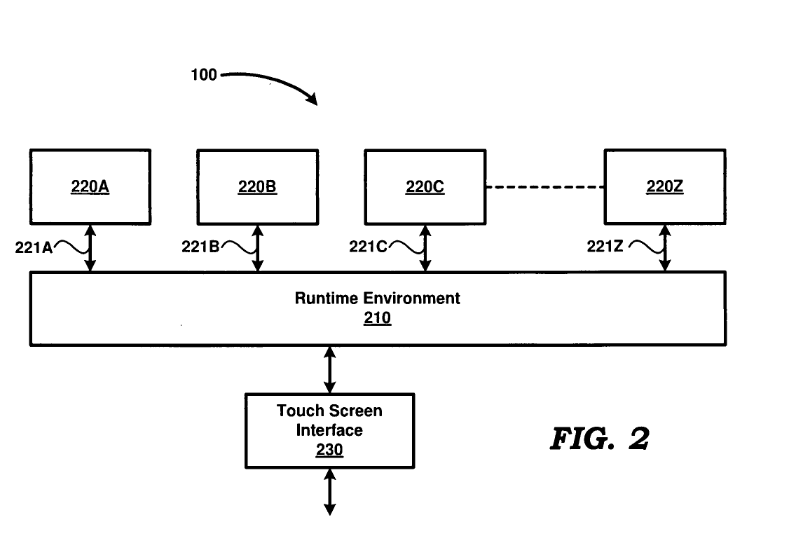

FIG. 2 is a block diagram illustrating an architecture for devices with small input areas and executing multiple applications, in one embodiment of the present invention. Handheld 100 is shown containing applications 220A-220Z, runtime environment 210 and touch screen interface 230. Each block is described in further detail below.

Again, merely for illustration, only representative number/types of blocks are shown in FIG. 2. However, input architecture according to several aspects of the present invention can contain many more/fewer/different blocks, both in number and type, depending on the purpose for which the environment is designed, as will be apparent to one skilled in the relevant arts.

Touch screen interface 230 interfaces with touch screen 130 to display the output received from runtime environment, as well as process touch data received from touch screen 130. In an embodiment, runtime environment 210 forms screens for display, and touch screen generates display signals to cause the corresponding display to be generated on the display portion.

Touch screen interface 230 forms touch data indicating the points touched, relative time points at which the point was touched, and point touch delay (i.e., how long was the point touched), etc., in response to the corresponding touch/movement on the touch screen (direction, start and end points, etc.). The touch data may then be forwarded to runtime environment.

Applications 220A-220Z correspond to various applications such as word processors, multimedia applications (for example, music players), calendars and schedulers, calculators, messaging applications, etc., executing in handheld 100, to provide the desired user experience. In general, each application provides for user interaction by providing an output (e.g., text/graphics display, sound, video, etc.) and receives input values.

Each application may invoke the appropriate interfaces (e.g., procedure/system calls) to define the output screen (e.g., that shown in FIG. 1) that needs to be displayed. In addition, appropriate interfaces may also be executed to request user inputs according to various aspects of the present invention as described in sections below. The output and input form the basis for the user to interact with the corresponding executing application.

Many applications may be executing in handheld 100 at the same time. For example, while a user is composing a message using a messaging application, the user may be listening to music being played by a music player application, while calendars and schedulers may be running to keep track of appointments, etc.

The applications executing on handheld 100 may require a user to make a choice from a small set of choices. For example, a user, composing a message in a text editor may be provided the choice to exit or continue from the editor upon selecting area 149. Alternatively, the text editor may request the user to indicate whether to save or not save, prior to exiting. The text editor may present a prompt (for example, Save Yes 171, No 172) on the display and request runtime environment 210 to fetch the user choice.

Runtime environment 210 facilitates access of various resources (including touch screen interface 230) to applications 220A-220Z based on appropriate interface procedures/routines/functions. The run time environment may contain the operating system, device drivers, etc., and are shared by all the application in accessing various resources.

As relevant to the illustrative example, in response to invocation of output interfaces, runtime environment 210 forms an image frame (or updates the previous frame) to be displayed on the display screen. The image frame may be used for periodic refresh of the display screen, as is well known in the relevant arts.

When a user input needs to be received (at least in respect of a small number of choices), the touch data may be processed according to various aspects of the present invention to determine the specific user choice, as described below in further detail with examples.

4. Providing a User Choice

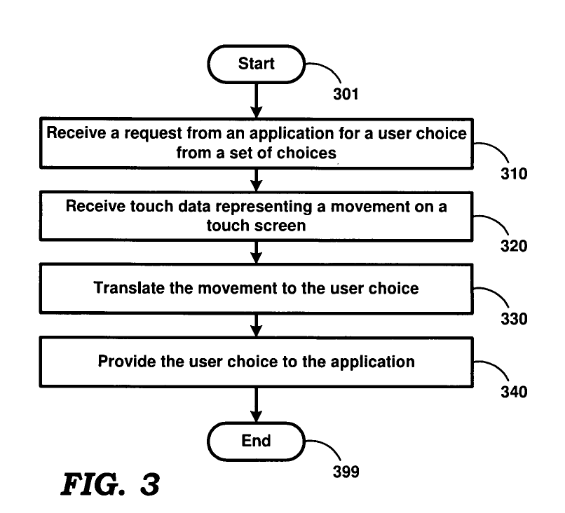

FIG. 3 is a flowchart illustrating the manner in which touch data may be processed to determine a user choice, in an embodiment of the present invention. The flowchart is described with respect to FIGS. 1-2 and in particular with respect to runtime environment 210 merely for illustration. However, various features can be implemented in other environments and other components/blocks without departing from several aspects of the present invention. Furthermore, the steps are described in a specific sequence merely for illustration.

Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 301, in which control passes immediately to step 310.

In step 310, runtime environment 210 receives a request from an application for a user choice. In an embodiment, the request indicates the type of choices and/or valid choices. For example, in case of Yes or No choice, the application may indicate that a character input is expected and it has to be one of Y or N (case insensitive). Similarly, in case a choice of up/down/left/right is required, the application may request that a direction indicator of 1, 2, 3 or 4 respectively for the four directions is required.

In step 320, runtime environment 210 receives touch data representing a movement on touch screen 130. The touch data may be received according to any convention and may represent various characteristics associated with the touches, as described above.

In step 330, runtime environment 210 translates the movement to a user choice. In an embodiment, runtime environment 210 examines the received touch data (for the present input being requested) into a single direction and maps the direction to one of the choices according to a convention. For example, in case of Yes or No input, down to up or left to right directions (or clock wise) may be viewed as a Y, while up to down or right to left (or counter clockwise) may be viewed as a N choice.

For simplicity and ease of use, a single direction is deemed to be sufficient for indicating user choices. However, in alternative embodiments, more complex directions can also be ascertained according to a corresponding pre-specified convention, and mapped to a corresponding user choice. In general, the set of movements forming a potential user choice is termed as a touch gesture.

In step 340, runtime environment 210 provides the user choice to the application, which may continue with execution flow based on the user choice. It should be appreciated that the specific user application to which the choice information needs to be delivered is generally determined based on the context. For example, the specific presently application to which an ‘active’ window (among respective windows caused by corresponding applications, executing in background as well) corresponds to may be determined to be the recipient. The flow chart ends in step 399.

It may thus be appreciated that potentially simple touch gestures are mapped to user choices. As the gestures depend primarily on direction of touch, accurate input choices may be provided without being constrained on the extent of area available for touch.

According to an aspect of the present invention, a user is provided the option of enabling the gesture based indication of choices. When the option is enabled, for all user choices from a small set of choices, only the gesture based inputs are accepted. Thus, assuming the feature is enabled and the display of FIG. 1 is provided, a user may even use the area 171 (on which Yes is displayed) to provide the direction corresponding to choice No by touching the display screen from right to left direction covering areas 172 and 171.

As an alternative, a single touch (at a point) on area 171 may be viewed as Yes choice, while a movement is interpreted according to the flowchart of FIG. 3 described above.

The description is continued with example configuration tables which may be used by runtime environment 210 to translate user movements on touch screen 130 into a user choice.

5. Configuration Tables

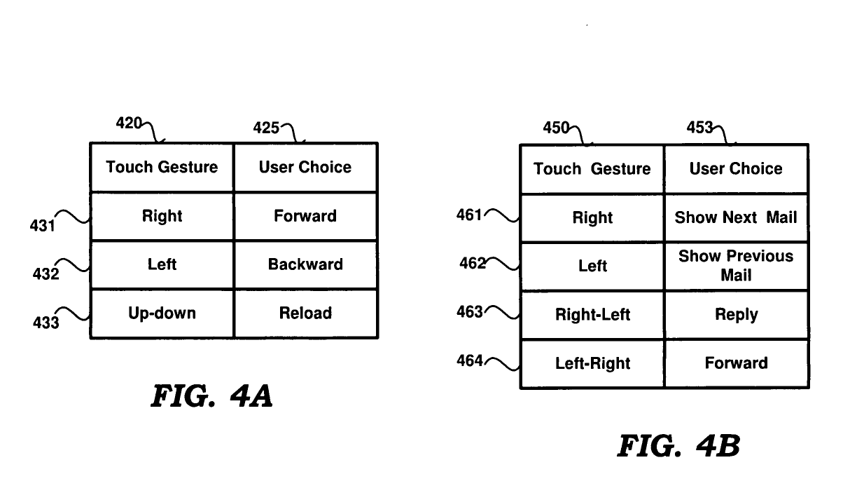

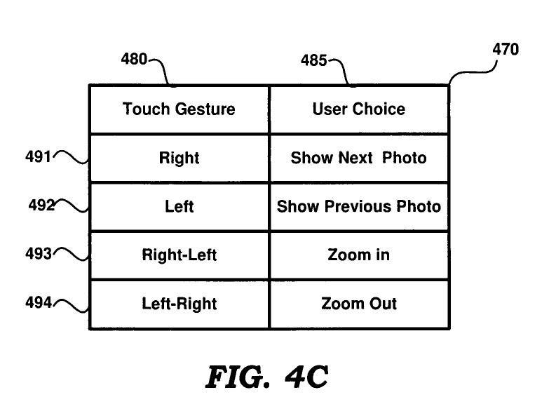

FIGS. 4A-4C depicts logically the configuration tables stored in a memory of handheld 100, in an embodiment. A separate configuration table may be stored for each of the sets of the user choices, consistent with the choices that may be offered to a user of that application. For illustration, it is assumed each set of user choices correspond to a different application, and the description is provided accordingly below.

Each of the tables may be user configurable to provide additional flexibility to respective users. For example, one user may indicate that left to right movement is to be interpreted as a Yes choice, while another user may indicate that the same movement is to be interpreted as a No choice.

Each configuration table is shown having two columns. The left column lists the valid movement that a user may make on touch screen 130 and the right column lists the corresponding user choice that may be provided to the application.

FIG. 4A depicts a configuration table that may be used with a web browser. The table is shown having two columns touch gesture 420, and user choice 425 and three rows, 431-434. Row 431 shows that a “right” movement (i.e., from left to right) by a user of a web browser, on touch screen 130, may be translated as a “Forward” user choice by touch screen interface 230, and provided to the web browser through runtime environment 210. Similarly, row 431 shows that “left” movement by a user may be translated as “Backward” user choice. Row 433 shows that a movement which is a combination of two directions “Up-Down” made by a user of the web browser on touch screen 130 may be translated as “Reload” user choice.

Similarly, FIG. 4B depicts a configuration table (with columns touch gesture 450, and user choice 453) for an email client application. Thus, rows 461-464 respectively indicate that right, left, right-left (i.e., while maintaining touch first from left to right followed by an immediate right to left movement), and left-right movements represent ‘Show next mail’, ‘Show Previous Email’, ‘Reply’, and ‘Forward’ actions. These choices can be understood, for example, with respect to Outlook Express™ Version 6.0 software available on various platforms.

FIG. 4C depicts a configuration table (with columns touch gesture 480 and user choice 485) for a photo viewer application, with rows 491-494 respectively indicating that right, left, right-left, and left-right movements represent ‘Show next photo’, ‘Show Previous Photo’, ‘Zoom in’, and ‘Zoom Out’ actions. These choices can be understood, for example, from Picaso™ software available from Google Corporation, Inc.

Thus, once the configuration information (tables above as well as indicating that the tables need to be used for user inputs) provided, run-time environment 210 may automatically convert the touch data to appropriate user choice, and provide the choice indication to the user application. Such conversion may be based on appropriate modifications to various input routines or procedures provided in the runtime environment.

In general, the input routines needs to be extended to recognize a touch data, potentially examine the appropriate configuration table to determine the manner in which to translate the touch data to a user choice, and provide the choice to the target user application. The implementation of such extensions will be apparent to one skilled in the relevant arts.

As noted above, run-time environment 210 generally has a convention (e.g., the application displaying the present active window on the display screen) by which to determine which user application the inputs need to be delivered, and the user choice is accordingly delivered to the determined user application.

In addition, due to the presence of the runtime environment shared by all the user applications, a single implementation can be used by any number applications (potentially executing in parallel) executing on handheld 100. While the display of FIG. 1 can be used to provide one user choice, it should be understood that many successive user choices can be provided for each application, when the application is executing in the foreground.

It may be further appreciated that all movements by a user on touch screen 130 have been shown as a sequence of one or more of (up, down, left, right) merely for illustration and may be extended to cover intermediate directions, for example, expressed as degrees from 0 to 360. Similarly, though the sequences are shown containing only one or two components, it may be extended to cover any number of components, as may be apparent to one skilled in the relevant arts.

6. Devices with Small Input Areas and Executing Multiple Applications

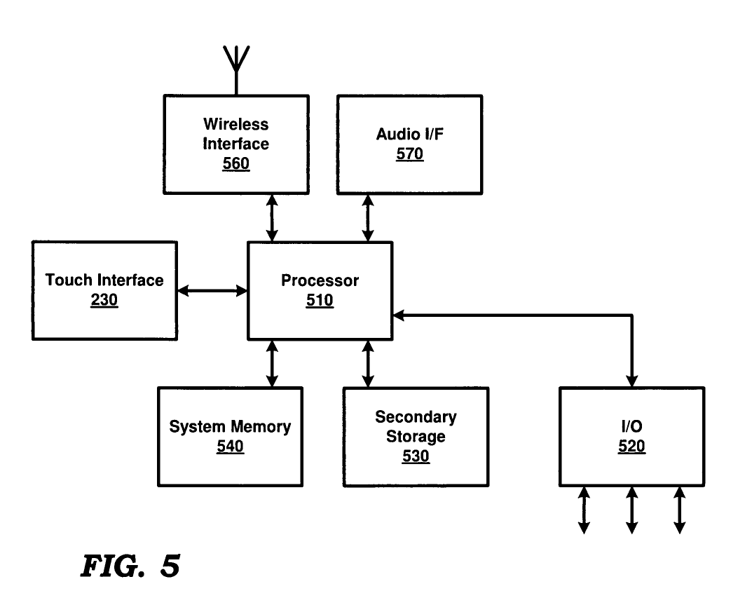

FIG. 5 is a block diagram illustrating the details of a device with small input area (handheld) in an embodiment of the present invention. Handheld device 100 is shown containing processor 510, I/O 520, secondary storage 530, system memory 540, touch screen 550, wireless interface 560, and audio interface 570. Each block is described in further detail below.

Merely for illustration, only representative number/type of blocks are shown in the Figure. Many environments often contain many more/fewer/different blocks, both in number and type, depending on the purpose for which the environment is designed, as will be apparent to one skilled in the relevant arts. For example, though the device is shown to operate as a mobile phone, some of such features may be removed to implement the handheld using fewer components.

Wireless interface 560 provides the physical (antenna, etc.), electronic (transmitter, receiver, etc.) and protocol (GSM, CDMA, etc.) interfaces necessary for handheld device 100 to communicate with a wireless network (not shown). In an embodiment, processor 510 may enable a user to communicate through voice, SMS, data, email, etc., using a user interface (not shown) presented on touch screen 550. Many such interfaces will be apparent to one skilled in the relevant arts. Thus, handheld 100 may optionally operate as a mobile phone, in addition to Internet access device (for email and web-browsing) and music player.

Audio interface 570 provides an audio output (through an inbuilt speaker or externally pluggable ear phones, etc.) and an audio input (through an inbuilt or externally pluggable microphone, etc.). The audio interface may be used when handheld device 100 operates as a mobile phone (to capture voice signals for transmission and reproduce received voice signals).

In addition, audio interface 570 may generate the audio signals representing songs when appropriate signals are received from processor 510. Thus, handheld 100 may optionally operate as a music player as well. In combination with touch screen 550, handheld 100 can operate as a multi-media player (playing combination of both video and audio signals, responsive to corresponding signals received from processor 510).

I/O (Input/Output) 520 provides the physical, electrical and protocol interfaces necessary to communicate with other devices using well known interfaces (for example, USB, wired or wireless Ethernet, Bluetooth, RS232, parallel interface, etc.). I/O 520 also provides the physical, electrical and protocol interfaces necessary for operation of keys 120, to enable a user to provide inputs to handheld 100, for example to answer a call, etc. by pressing the appropriate key/s.

System memory 540 contains randomly accessible locations to store program (instructions) and/or data, which are used by processor 510 during operation of handheld device 100. The data and instructions may be retrieved from secondary storage 530. The data retrieved may correspond to various configuration tables described above. The instructions, when executed, may similarly support the various applications (photo viewer, web browser, cell phone, music player, etc.). System Memory 540 may contain RAM (e.g. SRAM, SDRAM, DDR RAM, etc.), non-volatile memory (e.g. ROM, EEPROM, Flash Memory, etc.) or both.

Secondary storage 530 may contain hard drives, flash memory, removable storage drives, etc. Secondary memory 530 may store (on a non-volatile memory) the data and software instructions, which enable handheld device 100 to provide several features in accordance with the present invention. Secondary storage 510 may also store configuration tables for various applications.

In general, memory units (including RAMs, non-volatile memory, removable or not) from which instructions can be retrieved and executed by processors are referred to as a computer (or in general, machine) readable medium.

Processor 510 at least in substantial respects controls the operation (or non operation) of the various other blocks (in hand-held device 100) by executing instructions stored in system memory 540, to provide various features of the present invention. Some of the instructions executed by processor 510 also represent various user applications (e.g., photo viewer, web browser, cell phone, music player, etc.) provided by device 100.

Thus, using techniques described above, a user may provide inputs to an application executing on a device with small input areas and executing multiple applications.

7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A computer readable medium carrying one or more sequences of instructions for causing a operating environment to interface with a plurality of applications executing in a device with a small input area, wherein execution of said one or more sequences of instructions by one or more processors contained in said system causes said one or more processors to perform the actions of:
receiving a touch data representing a set of movements on a touch-area provided in said device;
mapping said set of movements to a user choice in a plurality of choices; and
indicating said user choice to a user application contained in said plurality of applications.

2. The computer readable medium of claim 1, wherein said mapping comprises: examining a mapping data in a memory to determine said user choice corresponding to said set of movements,
wherein said mapping data indicates a corresponding one of said plurality of choices for each set of movements, including that said set of movements corresponds to said user choice.

3. The computer readable medium of claim 2, wherein said mapping data is configurable by a user of said device to specify the specific user choice for each set of movements for each of said plurality of applications that can be executed in said device.

4. The computer readable medium of claim 2, wherein said user application requests said user choice and said operating environment provides said user choice in response.

5. The computer readable medium of claim 2, wherein said plurality of user choices contain only 2 choices, and said set of movements in one directions indicates one choice and set of movements in opposite direction indicates another choice.

6. The computer readable medium of claim 2, wherein said plurality of user choices comprise only four choices, and set of movements in up, down, left and right directions respectively indicate a first choice, a second choice, a third choice and a fourth choice.

7. The computer readable medium of claim 2, wherein said user application is a email application, wherein a left movement indicates show previous email choice, a right movement followed by left movement indicates a reply choice, a left movement followed by right movement indicates a forward email choice.

8. A method of enabling a user to provide user choices in a device having a small input area, said method comprising:
executing a plurality of applications in said device;
receiving a touch data representing a set of movements on a touch-area provided in said device;
mapping said set of movements to a user choice in a plurality of choices; and
indicating said user choice to a first user application contained in said plurality of user applications.

9. The method of claim 8, wherein said mapping is performed according to a first table associated with said first user application, further comprising:
receiving another touch data representing another set of movements for a second user application contained in said plurality of user applications;
examining a second table associated with said second user application to determine a second user action corresponding to said another set of movements; and
indicating said second user action to said second user application.

10. The method of claim 9, wherein said first table contains a first number of entries, and said second table contains a second number of entries, wherein said first number is not equal to said second number.

11. The method of claim 8, wherein said plurality of user choices contain only 2 choices, and said set of movements in one directions indicates one choice and set of movements in opposite direction indicates another choice.

12. The method of claim 8, wherein said plurality of user choices comprise only four choices, and set of movements in up, down, left and right directions respectively indicate a first choice, a second choice, a third choice and a fourth choice.

13. The method of claim 8, wherein said user application is a email application, wherein a left movement indicates show previous email choice, a right movement followed by left movement indicates a reply choice, a left movement followed by right movement indicates a forward email choice.

14. A device comprising:
an input area which is small;
a touch screen;
a plurality of user applications, each requiring one of a corresponding plurality of user choices; and
a runtime environment receiving a touch data representing a set of directions, translating said set of directions into a user choice, and providing said user choice to one of said plurality of user applications.

15. The device of claim 14, further comprising a memory to store a mapping data indicating a corresponding one of said plurality of choices for each set of movements, including that said set of movements corresponds to said user choice, wherein said runtime environment examines said mapping data to determine said user choice.

16. The device of claim 15, wherein said mapping data is configurable by a user of said device to specify the specific user choice for each set of movements for each of said plurality of applications that can be executed in said device.

17. The device of claim 14, wherein said plurality of user choices for a first application contain only 2 choices, and said set of movements in one directions indicates one choice and set of movements in opposite direction indicates another choice, wherein said first application is contained in said plurality of applications.

18. The device of claim 17, wherein said plurality of user choices comprise only four choices, and set of movements in up, down, left and right directions respectively indicate a first choice, a second choice, a third choice and a fourth choice, wherein said second application is contained in said plurality of applications.

19. The device of claim 18, wherein said user application is a email application, wherein a left movement indicates show previous email choice, a right movement followed by left movement indicates a reply choice, a left movement followed by right movement indicates a forward email choice, wherein said third application is contained in said plurality of applications.
